(19) United States
(12) Patent Application Publication
(10) Pub. No.: US 2017/0091629 A1
(43) Pub. Date: Mar. 30, 2017

(54) INTENT PLATFORM

(71) Applicant: LinkedIn Corporation, Mountain View, CA (US)

(72) Inventors: Lizabeth Li, Mountain View, CA (US); Zhijun Chen, Santa Clara, CA (US); Carrie Peng, Mountain View, CA (US); Christopher J. Fong, San Mateo, CA (US); Chanh Nguyen, Sunnyvale, CA (US); Michael Lin, Mountain View, CA (US)

(21) Appl. No.: 14/870,654

(22) Filed: Sep. 30, 2015

(51) Int. Cl. G06N 5/04; G06N 99/00; G06F 17/30

(52) U.S. Cl. CPC G06N 5/04; G06F 17/30867; G06F 17/3053; G06N 99/005

(57) ABSTRACT

Techniques for determining online content to provide to a member of an online social networking service based on their explicit and/or inferred intent are described. According to various embodiments, member profile data and user behavior log data associated with a member of an online social networking service is accessed. Based on the accessed data and a plurality of trained intent-specific machine learning models, a plurality of intent prioritization scores associated with a plurality of intents are generated, each intent prioritization score indicating an inferred likelihood that a member of the online social networking service is utilizing the online social networking service in connection with the corresponding intent. Thereafter, the plurality of intents are ranked, based on the plurality of intent prioritization scores, and one or more of the highest ranked intents are selected and displayed to the member.

### TECHNICAL FIELD

The present application relates generally to data processing systems and, in one specific example, to techniques for determining online content to provide to a member of an online social networking service based on their explicit and/or inferred intent.

### BACKGROUND

Online social network services such as LinkedIn® are becoming increasingly popular, with many such websites boasting millions of active members. Each member of the online social network service is able to add an editable member profile page to the online social network service. The member profile page may include various information about the member, such as the member's biographical information, photographs of the member, and information describing the member's employment history, education history, skills, experience, activities, and the like. Such member profile pages of the networking website are viewable by, for example, other members of the online social network service.

### BRIEF DESCRIPTION OF THE DRAWINGS

Some embodiments are illustrated by way of example and not limitation in the figures of the accompanying drawings in which:

FIG. 1 is a block diagram showing the functional components of a social networking service, consistent with some embodiments of the present disclosure;

FIG. 2 is a block diagram of an example system, according to various embodiments;

FIG. 3 illustrates an example portion of a user interface, according to various embodiments;

FIG. 4 is a flowchart illustrating an example method, according to various embodiments;

FIG. 5 illustrates an example portion of a user interface, according to various embodiments;

FIG. 6 is a flowchart illustrating an example method, according to various embodiments;

FIG. 7 illustrates an example portion of a user interface, according to various embodiments;

FIG. 8 is a flowchart illustrating an example method, according to various embodiments;

FIG. 9 illustrates an example mobile device, according to various embodiments; and

FIG. 10 is a diagrammatic representation of a machine in the example form of a computer system within which a set of instructions, for causing the machine to perform any one or more of the methodologies discussed herein, may be executed.

### DETAILED DESCRIPTION

Example methods and systems for determining online content to provide to a member of an online social networking service based on their explicit and/or inferred intent are described. In the following description, for purposes of explanation, numerous specific details are set forth in order to provide a thorough understanding of example embodiments. It will be evident, however, to one skilled in the art that the embodiments of the present disclosure may be practiced without these specific details.

The ecosystem of an online social networking service such as LinkedIn® is complex and serves many products and value propositions. Furthermore, many of these value propositions are not realized immediately, but over weeks and months, making it more difficult to convincingly demonstrate to members how a social network such as LinkedIn® can help them. Thus, the intent determination system described herein is configure to determine a member's intent for using an online social network, based on explicit user selections of goals/intents, and/or based on machine learning relevance models. Thereafter, the intent determination system is configured provide recommended tasks, a progress tracker, recommended products and applications, and other online content to the member that is personalized for the member based on their determined intent.

Accordingly, the intent determination system described herein helps members understand and discover why they should use an online social networking service such as LinkedIn®, helps them tailor their LinkedIn® experience according to their preferences, and provides a central repository/interface for understanding member intents and goals. Accordingly, the system described herein efficiently provides members with more relevant information, products and applications sooner, which reduces the need for further searching, browsing, experimentation and unnecessary application use on the part of the member. This may result in a reduction in the processing power and network bandwidth demands placed on online social network hardware and software infrastructure. This may also result in higher member engagement and satisfaction with the underlying products and value propositions offered by an online social networking service, due to the more tailored experiences provided to the member based on the determined intents.

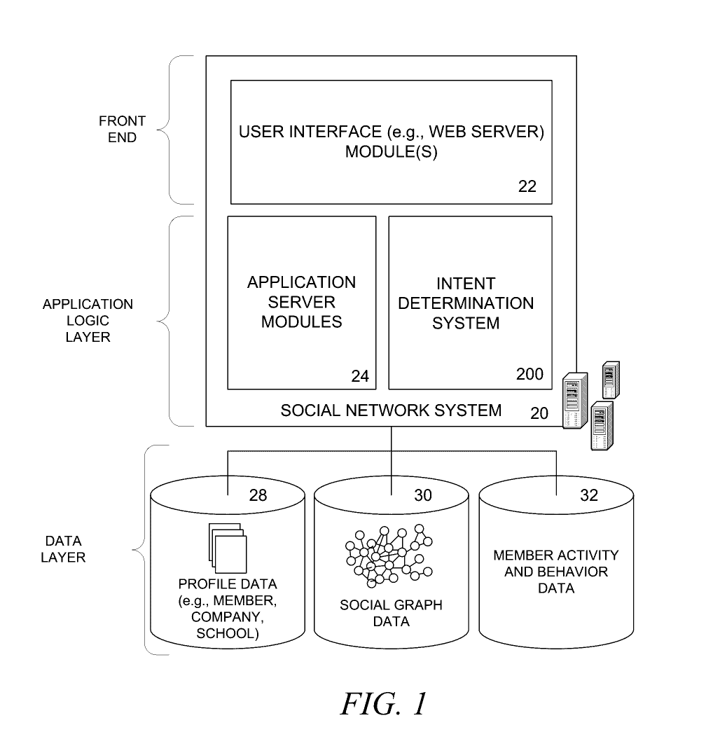

FIG. 1 is a block diagram illustrating various components or functional modules of a social network service such as the social network system 20, consistent with some embodiments. As shown in FIG. 1, the front end consists of a user interface module (e.g., a web server) 22, which receives requests from various client-computing devices, and communicates appropriate responses to the requesting client devices. For example, the user interface module(s) 22 may receive requests in the form of Hypertext Transport Protocol (HTTP) requests, or other web-based, application programming interface (API) requests. The application logic layer includes various application server modules 14, which, in conjunction with the user interface module(s) 22, generates various user interfaces (e.g., web pages) with data retrieved from various data sources in the data layer. With some embodiments, individual application server modules 24 are used to implement the functionality associated with various services and features of the social network service. For instance, the ability of an organization to establish a presence in the social graph of the social network service, including the ability to establish a customized web page on behalf of an organization, and to publish messages or status updates on behalf of an organization, may be services implemented in independent application server modules 24. Similarly, a variety of other applications or services that are made available to members of the social network service will be embodied in their own application server modules 24.

As shown in FIG. 1, the data layer includes several databases, such as a database 28 for storing profile data, including both member profile data as well as profile data for various organizations. Consistent with some embodiments, when a person initially registers to become a member of the social network service, the person will be prompted to provide some personal information, such as his or her name, age (e.g., birthdate), gender, interests, contact information, hometown, address, the names of the member's spouse and/or family members, educational background (e.g., schools, majors, matriculation and/or graduation dates, etc.), employment history, skills, professional organizations, and so on. This information is stored, for example, in the database with reference number 28. Similarly, when a representative of an organization initially registers the organization with the social network service, the representative may be prompted to provide certain information about the organization. This information may be stored, for example, in the database with reference number 28, or another database (not shown).

With some embodiments, the profile data 28 may be processed (e.g., in the background or offline) to generate various derived profile data. For example, if a member has provided information about various job titles the member has held with the same company or different companies, and for how long, this information can be used to infer or derive a member profile attribute indicating the member's overall seniority level, or seniority level within a particular company. With some embodiments, importing or otherwise accessing data from one or more externally hosted data sources may enhance profile data for both members and organizations. For instance, with companies in particular, financial data may be imported from one or more external data sources, and made part of a company's profile.

Once registered, a member may invite other members, or be invited by other members, to connect via the social network service. A “connection” may require a bi-lateral agreement by the members, such that both members acknowledge the establishment of the connection. Similarly, with some embodiments, a member may elect to “follow” another member. In contrast to establishing a connection, the concept of “following” another member typically is a unilateral operation, and at least with some embodiments, does not require acknowledgement or approval by the member that is being followed. When one member follows another, the member who is following may receive status updates or other messages published by the member being followed, or relating to various activities undertaken by the member being followed. Similarly, when a member follows an organization, the member becomes eligible to receive messages or status updates published on behalf of the organization. For instance, messages or status updates published on behalf of an organization that a member is following will appear in the member's personalized data feed or content stream. In any case, the various associations and relationships that the members establish with other members, or with other entities and objects, are stored and maintained within the social graph, shown in FIG. 1 with reference number 30.

The social network service may provide a broad range of other applications and services that allow members the opportunity to share and receive information, often customized to the interests of the member. For example, with some embodiments, the social network service may include a photo sharing application that allows members to upload and share photos with other members. With some embodiments, members may be able to self-organize into groups, or interest groups, organized around a subject matter or topic of interest. With some embodiments, the social network service may host various job listings providing details of job openings with various organizations.

As members interact with the various applications, services and content made available via the social network service, the members' behavior (e.g., content viewed, links or member-interest buttons selected, etc.) may be monitored and information concerning the member's activities and behavior may be stored, for example, as indicated in FIG. 1 by the database with reference number 32.

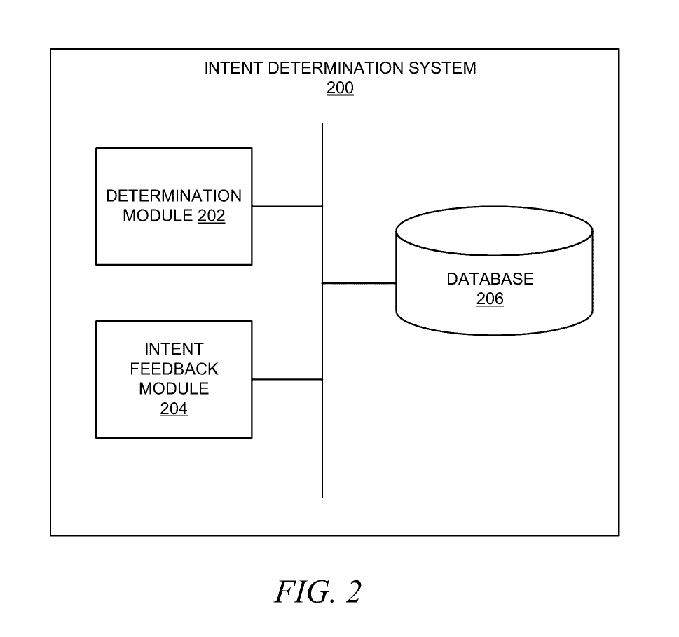

With some embodiments, the social network system 20 includes what is generally referred to herein as an intent determination system 200. The intent determination system 200 is described in more detail below in conjunction with FIG. 2.

Although not shown, with some embodiments, the social network system 20 provides an application programming interface (API) module via which third-party applications can access various services and data provided by the social network service. For example, using an API, a third-party application may provide a user interface and logic that enables an authorized representative of an organization to publish messages from a third-party application to a content hosting platform of the social network service that facilitates presentation of activity or content streams maintained and presented by the social network service. Such third-party applications may be browser-based applications, or may be operating system-specific. In particular, some third-party applications may reside and execute on one or more mobile devices (e.g., phone, or tablet computing devices) having a mobile operating system.

Turning now to FIG. 2, an intent determination system 200 includes a determination module 202, a request generation module 204, and a database 206. The modules of the intent determination system 200 may be implemented on or executed by a single device or on separate devices interconnected via a network (e.g., one or more client machines or application servers). The operation of each of the aforementioned modules of the intent determination system 200 will now be described in greater detail in conjunction with the various figures.

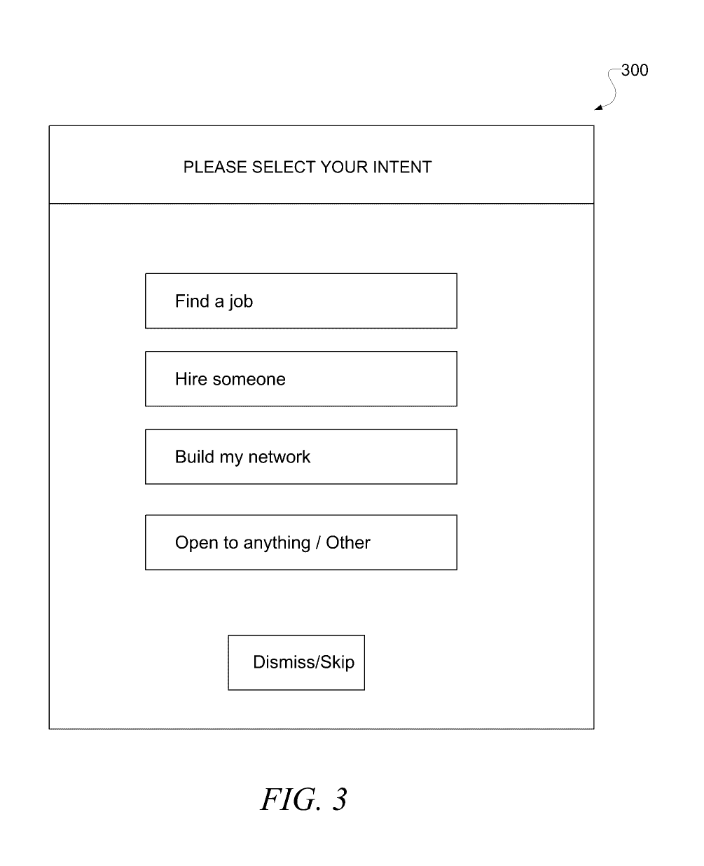

According to various examples, the determination module 202 is configured to determine an intent of a member of an online social networking service. For example, the intent determination system 200 may display a user interface that displays a plurality of predefined intents or goals (e.g., see FIG. 3), where the user is enabled to explicitly select one or more of the intents or goals (e.g., by selecting a user interface element or button associated with each intent or goal). An intent specified by the user in this manner is referred to throughout as an “explicit intent”. In some embodiments, if the member has selected different intents at different times, then the most recently selected intent may be classified as the determined intent (as opposed to intents selected earlier).

In other embodiments, the intent determination system 200 may infer the intent of the user rather than receive an explicit selection of intent. For example, the intent determination system 200 may generate online or offline models of member behavior across a member base, in order to predict or infer the likelihood that a given member has a given intent (e.g., given the member's previous actions and member profile data). For example, the intent determination system 200 may generate a machine learning model, such as a logistic regression model, configured to predict the likelihood or probability that a given member, with given member profile attributes and a known member behavior, has a given intent such as “build my network”. Such a model may be trained based on positive and/or negative training data of other members that have or have not explicitly specified that they have the corresponding intent (e.g., via the user interface in FIG. 3). For example, the positive training data may include feature vectors with feature data associated with each member of the online social networking service (or a large set of members, such as 10,000-1 million members) that has explicitly specified that they have the intent such as “build my network” (e.g., via the user interface in FIG. 3). For example, feature data for each member may be stored in a feature vector, where the feature data indicates member profile data of the member (e.g., company, location, education, skills, etc.), behavior log data of the member (e.g., what content they viewed or clicked on and when, what products or apps they utilized and when, search history, what platforms they used such as desktop, mobile, table, etc.), and a value (e.g., 1) indicating that they have explicitly specified the respective intent (e.g., via the user interface in FIG. 3). Similarly, the negative training data may include feature vectors with feature data associated with each member of the online social networking service (or a large set of members, such as 10,000-1 million members) that has not explicitly specified that they have the intent such as “build my network” (e.g., via the user interface in FIG. 3). For example, feature data for each member may be stored in a feature vector, where the feature data indicates member profile data of the member and behavior log data of the member, and a value (e.g., 0) indicating that they have not explicitly specified the respective intent (e.g., via the user interface in FIG. 3). Accordingly, based on such training feature data, the coefficients of a logistic regression model may be trained to generate a trained machined learned model configured to predict the likelihood that a member has a given intent. Using this machine learning model, feature data of a new or current member may be input into the model in order to determine the probability that they have the intent such as “build my network” (or the probability that they would have explicitly specified this intent if presented with the prompt in FIG. 3). The determination module 202 may repeat this process for each intent, in order to generate a number of intent-specific machine learning models, such as a model for predicting the likelihood that a member has the intent of “help finding a job”, a model for predicting the likelihood that a member has the intent of “hire a member”, and so on.

In some embodiments, the member profile attributes described above include location, role, industry, language, current job, employer, experience, skills, education, school, endorsements, seniority level, company size, connections, connection count, account level, name, username, social media handle, email address, phone number, fax number, resume information, title, activities, group membership, images, photos, preferences, news, status, links or URLs on a profile page, and so forth.

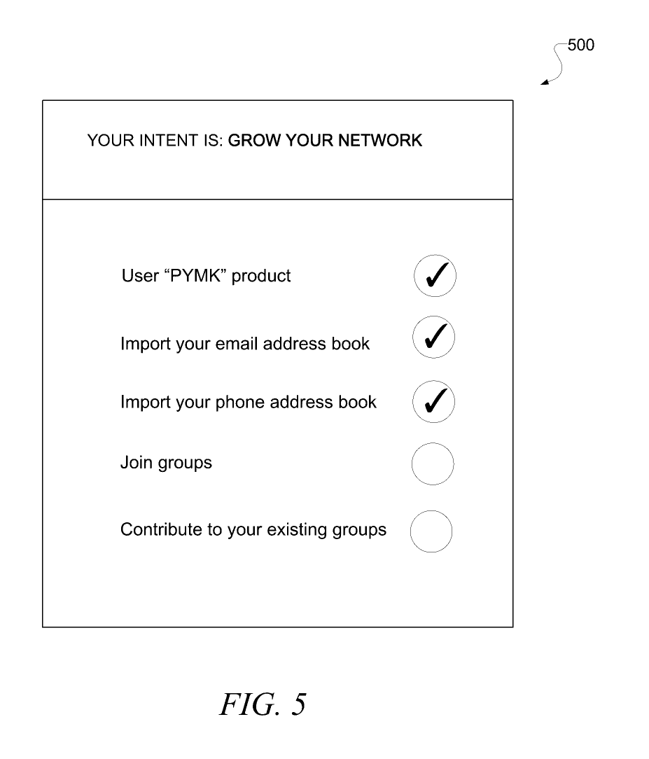

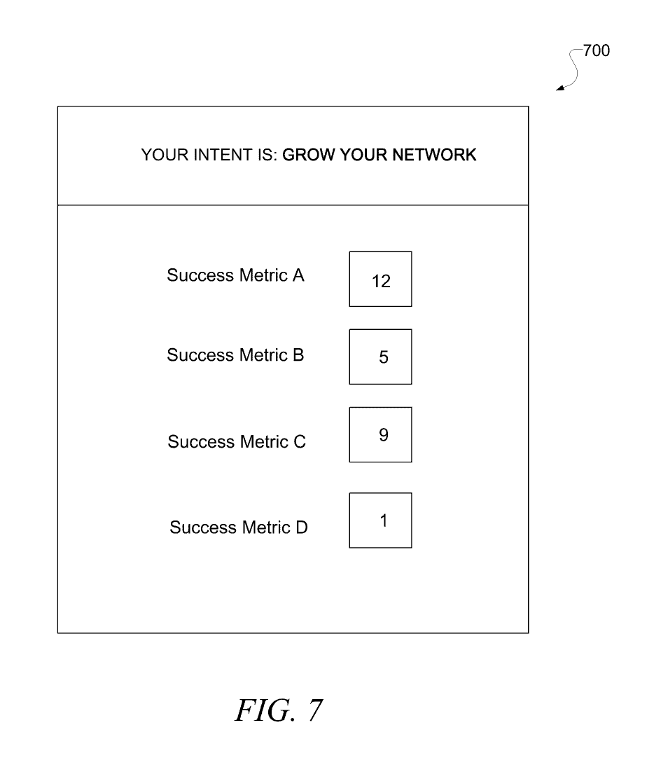

In some embodiments, the intent determination system 200 may display the determined intent to the member (e.g., see FIGS. 5 and 7). In some embodiments, all intents will be private to the member and will not displayed to other members. In other embodiments, a member may specify visibility rules such that their intents are private, only displayed to certain members, friends, or connections, only displayed to all first degree connections, or displayed to everyone on the social networking service. Thus, a member with the intent of “find a mentor” may choose to display this intent publicly on their member profile page, so that other viewers viewing that member profile page may reach out to the member to offer mentorship services, etc.

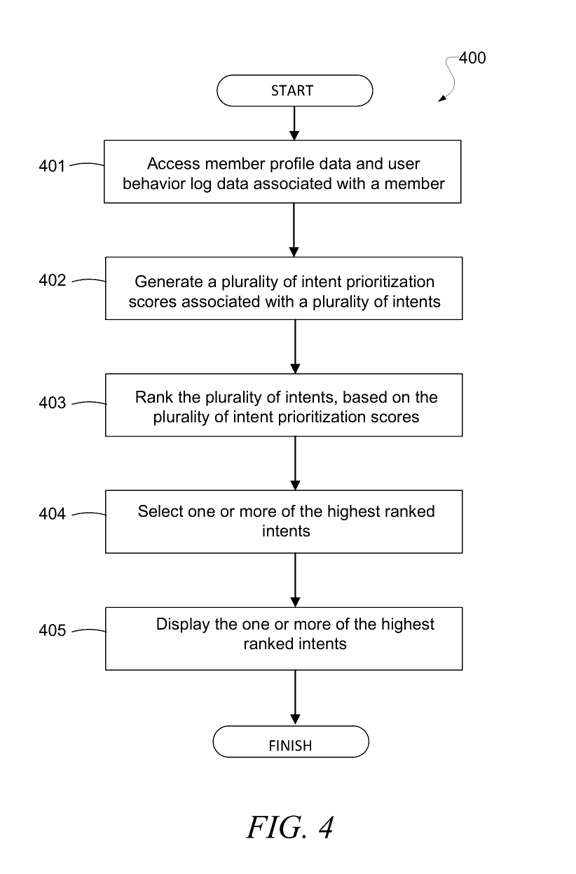

FIG. 4 is a flowchart illustrating an example method 400, consistent with various embodiments described herein. The method 400 may be performed at least in part by, for example, the intent determination system 200 illustrated in FIG. 2 (or an apparatus having similar modules, such as one or more client machines or application servers). In operation 401, the determination module 202 accesses member profile data and user behavior log data associated with a member of an online social networking service. In operation 402, the determination module 202 generates, based on the data accessed in operation 401 and a plurality of trained intent-specific machine learning models, a plurality of intent prioritization scores associated with a plurality of intents. Thus, each intent-specific machine learning model corresponds to a different intent (each job seeker machine learning model corresponding to a job seeker intent, a separate ‘build my network’ machine learning model corresponding to a ‘build my network’ intent, etc.), and is configured to calculate an intent prioritization score for that intent. Each intent prioritization score may indicate an inferred likelihood that a member of the online social networking service is utilizing the online social networking service in connection with the corresponding intent. In some embodiments, each intent-specific machine learning model is trained by: accessing a set of feature data associated with each of a plurality of members of the online social networking service, each set of feature data indicating member profile data and user behavior log data associated with the corresponding member and a value indicating whether the corresponding member explicitly specified the relevant intent. Each intent-specific machine learning model may be trained based on the corresponding feature data. In some examples, the set of feature data used to train a first one of the plurality of machine learning models may be the same as used to train a second one of the plurality of machine learning models, but in other examples, the sets may include one or more different features.

In operation 403, the determination module 202 ranks the plurality of intents, based on the plurality of intent prioritization scores in operation 402. In operation 404, the determination module 202 selects or more of the highest ranked intents that were ranked in operation 403. In operation 405, the determination module 202 displays to the member, via a user interface, the one or more of the highest ranked intents that were selected in operation 404. It is contemplated that the operations of method 400 may incorporate any of the other features disclosed herein. Various operations in the method 400 may be omitted or rearranged.

In some embodiments, some intents may not be available to all users, particularly on a locale or function basis. For instance, the intent eligibility rules may state that members with a current location in Country X (as determined based on location attributes associated with those members) may not be eligible for the “Stay informed” intent due to the lack of content available there. As another example, the intent eligibility rules may state that members that are not salespeople (as determined based on function attributes associated with those members) may not be eligible for the “prospect for leads” intent. Thus, in some embodiments, the intent determination system 200 may access intent eligibility rules (e.g., stored in the database 206) that identify criteria regarding whether a particular candidate intent is applicable to a particular user with certain member profile attributes. If the intent eligibility rules indicate that a particular candidate intent is not applicable to a plurality user, then the intent determination system 200 need not generate an intent prioritization score associated with this candidate intent and the particular user (e.g., see method 400 in FIG. 4). The aforementioned intent eligibility rules may be stored in the database 206.

In some embodiments, the intent determination system 200 may utilize impression capping or cool-off features to ensure that members are not requested to specify their intent unnecessarily or too often. For example, if a member has already specified a goal/intent recently, the intent determination system 200 may not ask for any new goals/intents (e.g., for at least a predetermined time interval after the member specified their goal/intent). As another example, if the member has already been asked for a goal/intent recently, and ignored the question, then the intent determination system 200 may cool off asking for intents based on an “ignore” cool-off period (e.g., for at least a predetermined time interval after the member ignored the request to specify a goal/intent). As another example, if the member has already been asked for a goal/intent recently, and dismissed or skipped the question (e.g., see FIG. 3), then the system 200 may cool off asking for intents based on a “dismiss/skip” cool-off period (e.g., for at least a predetermined time interval after the member dismissed/skipped the request to specify a goal/intent). As another example, if the member has chosen the “open to anything/other” option when asked for a goal/intent recently (e.g., see FIG. 3), then the intent determination system 200 may cool off asking for intents based on a “other” cool-off period (e.g., for at least a predetermined time interval after the member specified the “open to anything/other” option). Instead of the aforementioned cool-off periods, impression caps may be utilized (e.g., do not show prompt X more than Y times during time interval Z). Information describing the aforementioned cool-off periods and impression caps may be stored in the database 206.

As described above, the intent determination system 200 may generate a plurality of intent prioritization scores associated with a plurality of intents, each intent prioritization score indicating an inferred likelihood that a member has the corresponding intent while using the an online social networking service. In some embodiments, the intent determination system 200 may modify each of the intent prioritization scores based on the business logic rules stored in the database 206. For example, the business logic rules may specify weights associated with each intent, such as a weight of 2 associated with the intent of “help finding a job”, a weight of 1.8 associated with the intent of “hire a member”, a weight of 0.9 associated with the intent of “stay informed”, and so on. Thus, once the intent prioritization scores are determined for each of the intents for a given member, each of the determined intent prioritization scores may be modified based on the appropriate weights associated with each of the intents. In this way, the intent determination system 200 may prioritize intents based on business logic, such that the intent of “help finding a job” is more likely to be associated with a member than the intent of “hire a member” or “stay informed”, etc.

In some embodiments, the intent determination system 200 may modify the products, online content, or applications displayed to the user, based on the determined intent of the user (e.g. the explicit intent and/or inferred intent with the highest intent prioritization score). In some embodiments, the intent determination system 200 may access a list of recommended tasks associated with the determined intent (e.g. the explicit intent and/or inferred intent with the highest intent prioritization score), and display the list of recommended tasks to the member (e.g., see FIG. 5). In some embodiments, the intent determination system 200 may determine the tasks already performed by the user, and remove those tasks from the list of recommended tasks to thereby generate a revised list of recommended tasks, and then display the revised list of recommended tasks to the user. The list of recommended tasks associated with each candidate intent may be stored at, for example, the database 206.

In some embodiments, the list of recommended tasks associated with each intent/goal may be specified manually by a user, such as an operator of the intent determination system 200 (e.g., administrator or website personnel). For example, the intent determination system 200 may display a user interface that enables an operator of the intent determination system 200 to specify (e.g., by typing text into the user interface) a set of recommended tasks associated with each of various intents/goals.

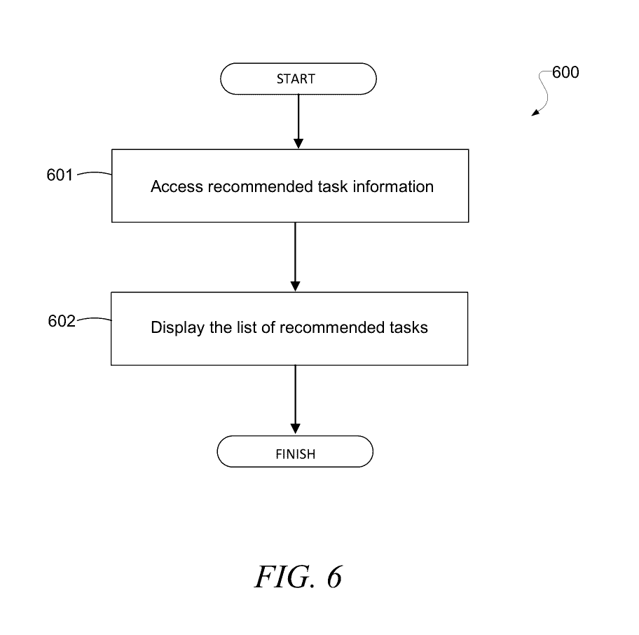

FIG. 6 is a flowchart illustrating an example method 600, consistent with various embodiments described herein. The method 600 may be performed at least in part by, for example, the intent determination system 200 illustrated in FIG. 2 (or an apparatus having similar modules, such as one or more client machines or application servers). In operation 601, the intent feedback module 204 accesses recommended task information identifying a list of recommended tasks associated with an intent (e.g., the explicit intent and/or inferred intent with the highest intent prioritization score as determined in method 400). In operation 602, the intent feedback module 204 displays the list of recommended tasks accessed in operation 601 via a user interface (e.g., see FIG. 5). It is contemplated that the operations of method 600 may incorporate any of the other features disclosed herein. Various operations in the method 600 may be omitted or rearranged.

In some embodiments, after the intent determination system 200 determines an intent of a member (e.g., the explicit intent and/or inferred intent with the highest intent prioritization score as determined in method 400), the intent determination system 200 may display a progress tracker associated with the determined intent. In some embodiments, the aforementioned progress tracker may correspond to success metrics (e.g., see FIG. 7), where such success metrics may help the user understand how successful they are or how close they are to achieving their goal/intent. Information describing success metrics associated with each intent may be stored in the database 206. Examples of success metrics associated with different example intents are described below.

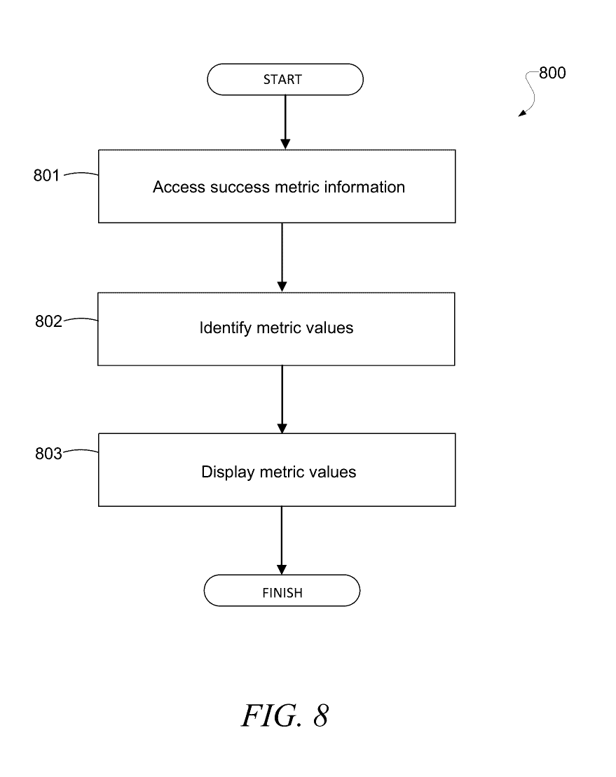

FIG. 8 is a flowchart illustrating an example method 800, consistent with various embodiments described herein. The method 800 may be performed at least in part by, for example, the intent determination system 200 illustrated in FIG. 2 (or an apparatus having similar modules, such as one or more client machines or application servers). In operation 801, the intent feedback module 204 accesses success metric information identifying one or more success metrics associated with an intent (e.g., the explicit intent and/or inferred intent with the highest intent prioritization score as determined in method 400). In operation 802, the intent feedback module 204 identifies metric values associated with the success metrics identified in operation 801. For example, if the success metric is “number of companies followed”, then the intent feedback module 204 will determine the actual number of companies currently being followed by the member. In operation 803, the intent feedback module 204 displays the metric values associated with the identified success metrics that were calculated in operation 802 via a user interface (e.g., see FIG. 7). It is contemplated that the operations of method 800 may incorporate any of the other features disclosed herein. Various operations in the method 800 may be omitted or rearranged.

### Example Intents

In some embodiments, an example of a goal/intent is “Help finding a job”. Examples of recommended tasks for this intent may include: download and use the job seeker app; search, view, and save function/industry jobs in location; Search, view, and follow relevant companies in location; add function/industry and related skills to your profile; view job recommendations or a “Jobs You May Be Interested In” product; view company recommendations or a “Companies you may want to follow” product; view profiles of people who are in function/location/company (and compare and edit your profile to match theirs); Update your profile with keyword suggestions; update your profile in general; connect to people identified in a “People you may know” product who are in function/industry/location/company; add relevant work to Treasury; Follow Influencers/people in function/industry; reach out to people in your network in function/industry/location/company; reach out to people not in your network in function/industry/location/company; follow up with recruiters directly; ask for recommendations; share articles about function/industry to establish your expertise; write articles about function/industry to establish your expertise; follow the function/industry channel; join and contribute to groups related to your function/industry; get Job Seeker Premium application; and view and contact recruiters from a “Who's viewed my profile” product. Examples of success metrics for this intent may include: Saved Jobs; Saved Job Searches; Followed companies (with a list or a reference link to latest associated updates); Influencers Followed (with a list or a reference link to latest associated updates); Followed Channels (with a list or a reference link to latest associated updates); and Joined Groups (with a list or a reference link to latest associated updates). In some embodiments, the intent determination system 200 may display a people search, jobs search, or company search user interface that has a pre-selected function, location, industry, company, company size, experience level, and/or skill search facet corresponding to a member profile attribute of the member, and that is configured to generate search results (of members, jobs, or companies) based on the pre-selected search facet. The aforementioned search results may assist the member in realizing their goals/intent.

In some embodiments, an example of a goal/intent is “Hire a member”. Examples of recommended tasks for this intent may include: post a job on LinkedIn; share a job posting on LinkedIn; reach out to people in your network in function/industry/location/company; search and view people with function/skill/industry/company/seniority/years of experience in location; edit summary of what you're looking for to your profile; add link to job posting to profile; join groups in function/skill/industry/company; connect to people identified in a “People you may know” product who are in function/industry/location/company; get LinkedIn® Recruiter product; and download and use the LinkedIn® Recruiter app. Examples of success metrics for this intent may include: Views on job posting; Applicants to job posting; and Joined groups (with a list or a reference link to latest associated updates). In some embodiments, the intent determination system 200 may display a people, job, or company search user interface that has a pre-selected function, location, industry, current and past company, skill, seniority, experience level, and years of experience search facet corresponding to a member profile attribute of the member, and that is configured to generate search results (of members, jobs, or companies) based on the pre-selected search facet. The aforementioned search results may assist the member in realizing their goals/intent.

In some embodiments, an example of a goal/intent is “Find and contact people”. Examples of recommended tasks for this intent may include: connect to people identified in a “People you may know” product; search, view, and contact people (e.g., people in your function, location, industry, company, title, keywords); ask for introductions from 1st degree to 2^{nd} Degree connections (e.g., people in your function, location, industry, company, title, keywords); join groups (e.g., with people in your function, location, industry, company, title, keywords); get LinkedIn® Premium; and view and contact people identified in a “Who's viewed my profile” product. Examples of success metrics for this intent may include Joined groups (with a list or a reference link to latest associated updates). In some embodiments, the intent determination system 200 may display a people search user interface that has a pre-selected function, location, industry, company, title, or keywords search facet corresponding to a member profile attribute of the member, and that is configured to generate search results of members based on the pre-selected search facet. The aforementioned search results may assist the member in realizing their goals/intent.

In some embodiments, an example of a goal/intent is “Build my network”. Examples of recommended tasks for this intent may include: connect to people identified in a “People you may know” product; import your email address book; import your phone address book; join groups; contribute to your existing groups; share articles to attract followers and future connections (e.g., via LinkedIn® Pulse product); and write articles to attract followers and future connections (e.g., via LinkedIn® Pulse product). Examples of success metrics for this intent may include: Connections in the last Month (with a list or a reference link to latest associated updates); and Joined Groups (with a list or a reference link to latest associated updates). In some embodiments, the intent determination system 200 may display a people search user interface that has a pre-selected current or past company or school search facet corresponding to a member profile attribute of the member, and that is configured to generate search results of members based on the pre-selected search facet. The aforementioned search results may assist the member in realizing their goals/intent.

The examples intents described are not limiting, and the techniques described herein are applicable to any other intent that a member may have in connection with using an online social networking service such as LinkedIn®.

### Example Prediction Models

As described above, the determination module 202 may use any one of various known prediction modeling techniques to perform the prediction modeling. For example, according to various exemplary embodiments, the determination module 202 may apply a statistics-based machine learning model such as a logistic regression model to the member profile data and/or behavioral log data associated with one or more members of an online social network (where the behavioral log data may indicate whether a member explicitly selected an intent, such as via the user interface displayed in FIG. 3). As understood by those skilled in the art, logistic regression is an example of a statistics-based machine learning technique that uses a logistic function. The logistic function is based on a variable, referred to as a logit. The logit is defined in terms of a set of regression coefficients of corresponding independent predictor variables. Logistic regression can be used to predict the probability of occurrence of an event given a set of independent/predictor variables. A highly simplified example machine learning model using logistic regression may be ln [p/(1−p)]=a+BX+e, or [p/(1−p)]=exp(a+BX+e), where In is the natural logarithm, logₑₓₚ, where exp=2.71828 . . . , p is the probability that the event Y occurs, p(Y=1), p/(1−p) is the “odds ratio”, ln [p/(1−p)] is the log odds ratio, or “logit”, a is the coefficient on the constant term, B is the regression coefficient(s) on the independent/predictor variable(s), X is the independent/predictor variable(s), and e is the error term. In some embodiments, the independent/predictor variables of the logistic regression model may correspond to member profile data or behavioral log data associated with members of an online social network service (where the aforementioned member profile data or behavioral log data may be encoded into numerical values and inserted into feature vectors). The regression coefficients may be estimated using maximum likelihood or learned through a supervised learning technique from the recruiting intent signature data, as described in more detail below. Accordingly, once the appropriate regression coefficients (e.g., B) are determined, the features included in a feature vector (e.g., member profile data and/or behavioral log data associated with one or more members of a social network service) may be applied to the logistic regression model in order to predict the probability (or “confidence score”) that the event Y occurs (where the event Y may be, for example, a member having a given intent when using the social networking service or explicitly selecting a given intent from a user interface such that displayed in FIG. 3). In other words, provided a feature vector including various member profile data and/or behavioral features associated with members, the feature vector may be applied to a logistic regression model to determine the probability that a member has a given intent when using the social networking service. Logistic regression is well understood by those skilled in the art, and will not be described in further detail herein, in order to avoid occluding various aspects of this disclosure. The intent feedback module 204 may use various other prediction modeling techniques understood by those skilled in the art to generate the aforementioned confidence score. For example, other prediction modeling techniques may include other computer-based machine learning models such as a gradient-boosted machine (GBM) model, a Naïve Bayes model, a support vector machines (SVM) model, a decision trees model, and a neural network model, all of which are understood by those skilled in the art.

According to various embodiments described above, the feature data may be used for the purposes of both off-line training (for generating, training, and refining a prediction model and or the coefficients of a prediction model) and online inferences (for generating confidence scores). For example, if the determination module 202 is utilizing a logistic regression model (as described above), then the regression coefficients of the logistic regression model may be learned through a supervised learning technique from the feature data. Accordingly, in one embodiment, the intent determination system 200 may operate in an off-line training mode by assembling the feature data into feature vectors. The feature vectors may then be passed to the determination module 202, in order to refine regression coefficients for the logistic regression model. For example, statistical learning based on the Alternating Direction Method of Multipliers technique may be utilized for this task. Thereafter, once the regression coefficients are determined, the intent determination system 200 may operate to perform online (or offline) inferences based on the trained model (including the trained model coefficients) on a feature vector representing the feature data of a particular member of the online social network service. According to various exemplary embodiments, the off-line process of training the prediction model based on member profile data and behavioral log data may be performed periodically at regular time intervals (e.g., once a day), or may be performed at irregular time intervals, random time intervals, continuously, etc. Thus, since member profile data and behavioral log data may change over time, it is understood that the prediction model itself may change over time (based on the current member profile data and behavioral log data used to train the model).

### Example Mobile Device

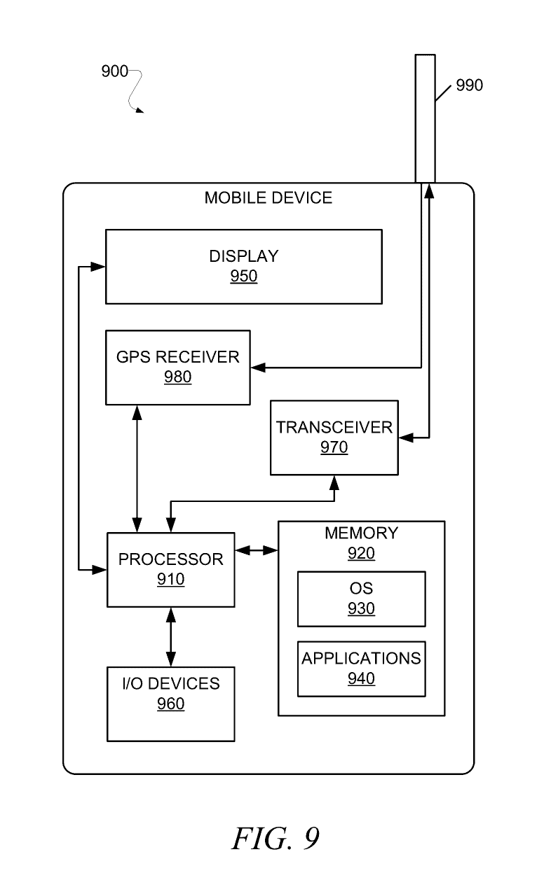

FIG. 9 is a block diagram illustrating the mobile device 900, according to an example embodiment. The mobile device may correspond to, for example, one or more client machines or application servers. One or more of the modules of the system 200 illustrated in FIG. 2 may be implemented on or executed by the mobile device 900. The mobile device 900 may include a processor 910. The processor 910 may be any of a variety of different types of commercially available processors suitable for mobile devices (for example, an XScale architecture microprocessor, a Microprocessor without Interlocked Pipeline Stages (MIPS) architecture processor, or another type of processor). A memory 920, such as a Random Access Memory (RAM), a Flash memory, or other type of memory, is typically accessible to the processor 910. The memory 920 may be adapted to store an operating system (OS) 930, as well as application programs 940, such as a mobile location enabled application that may provide location based services to a user. The processor 910 may be coupled, either directly or via appropriate intermediary hardware, to a display 950 and to one or more input/output (I/O) devices 960, such as a keypad, a touch panel sensor, a microphone, and the like. Similarly, in some embodiments, the processor 910 may be coupled to a transceiver 970 that interfaces with an antenna 990. The transceiver 970 may be configured to both transmit and receive cellular network signals, wireless data signals, or other types of signals via the antenna 990, depending on the nature of the mobile device 900. Further, in some configurations, a GPS receiver 980 may also make use of the antenna 990 to receive GPS signals.

### Modules, Components and Logic

Certain embodiments are described herein as including logic or a number of components, modules, or mechanisms. Modules may constitute either software modules (e.g., code embodied (1) on a non-transitory machine-readable medium or (2) in a transmission signal) or hardware-implemented modules. A hardware-implemented module is a tangible unit capable of performing certain operations and may be configured or arranged in a certain manner. In example embodiments, one or more computer systems (e.g., a standalone, client or server computer system) or one or more processors may be configured by software (e.g., an application or application portion) as a hardware-implemented module that operates to perform certain operations as described herein.

In various embodiments, a hardware-implemented module may be implemented mechanically or electronically. For example, a hardware-implemented module may comprise dedicated circuitry or logic that is permanently configured (e.g., as a special-purpose processor, such as a field programmable gate array (FPGA) or an application-specific integrated circuit (ASIC)) to perform certain operations. A hardware-implemented module may also comprise programmable logic or circuitry (e.g., as encompassed within a general-purpose processor or other programmable processor) that is temporarily configured by software to perform certain operations. It will be appreciated that the decision to implement a hardware-implemented module mechanically, in dedicated and permanently configured circuitry, or in temporarily configured circuitry (e.g., configured by software) may be driven by cost and time considerations.

Accordingly, the term “hardware-implemented module” should be understood to encompass a tangible entity, be that an entity that is physically constructed, permanently configured (e.g., hardwired) or temporarily or transitorily configured (e.g., programmed) to operate in a certain manner and/or to perform certain operations described herein. Considering embodiments in which hardware-implemented modules are temporarily configured (e.g., programmed), each of the hardware-implemented modules need not be configured or instantiated at any one instance in time. For example, where the hardware-implemented modules comprise a general-purpose processor configured using software, the general-purpose processor may be configured as respective different hardware-implemented modules at different times. Software may accordingly configure a processor, for example, to constitute a particular hardware-implemented module at one instance of time and to constitute a different hardware-implemented module at a different instance of time.

Hardware-implemented modules can provide information to, and receive information from, other hardware-implemented modules. Accordingly, the described hardware-implemented modules may be regarded as being communicatively coupled. Where multiple of such hardware-implemented modules exist contemporaneously, communications may be achieved through signal transmission (e.g., over appropriate circuits and buses) that connect the hardware-implemented modules. In embodiments in which multiple hardware-implemented modules are configured or instantiated at different times, communications between such hardware-implemented modules may be achieved, for example, through the storage and retrieval of information in memory structures to which the multiple hardware-implemented modules have access. For example, one hardware-implemented module may perform an operation, and store the output of that operation in a memory device to which it is communicatively coupled. A further hardware-implemented module may then, at a later time, access the memory device to retrieve and process the stored output. Hardware-implemented modules may also initiate communications with input or output devices, and can operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some example embodiments, comprise processor-implemented modules.

Similarly, the methods described herein may be at least partially processor-implemented. For example, at least some of the operations of a method may be performed by one or processors or processor-implemented modules. The performance of certain of the operations may be distributed among the one or more processors, not only residing within a single machine, but deployed across a number of machines. In some example embodiments, the processor or processors may be located in a single location (e.g., within a home environment, an office environment or as a server farm), while in other embodiments the processors may be distributed across a number of locations.

The one or more processors may also operate to support performance of the relevant operations in a “cloud computing” environment or as a “software as a service” (SaaS). For example, at least some of the operations may be performed by a group of computers (as examples of machines including processors), these operations being accessible via a network (e.g., the Internet) and via one or more appropriate interfaces (e.g., Application Program Interfaces (APIs).)

### Electronic Apparatus and System

Example embodiments may be implemented in digital electronic circuitry, or in computer hardware, firmware, software, or in combinations of them. Example embodiments may be implemented using a computer program product, e.g., a computer program tangibly embodied in an information carrier, e.g., in a machine-readable medium for execution by, or to control the operation of, data processing apparatus, e.g., a programmable processor, a computer, or multiple computers.

A computer program can be written in any form of programming language, including compiled or interpreted languages, and it can be deployed in any form, including as a stand-alone program or as a module, subroutine, or other unit suitable for use in a computing environment. A computer program can be deployed to be executed on one computer or on multiple computers at one site or distributed across multiple sites and interconnected by a communication network.

In example embodiments, operations may be performed by one or more programmable processors executing a computer program to perform functions by operating on input data and generating output. Method operations can also be performed by, and apparatus of example embodiments may be implemented as, special purpose logic circuitry, e.g., a field programmable gate array (FPGA) or an application-specific integrated circuit (ASIC).

The computing system can include clients and servers. A client and server are generally remote from each other and typically interact through a communication network. The relationship of client and server arises by virtue of computer programs running on the respective computers and having a client-server relationship to each other. In embodiments deploying a programmable computing system, it will be appreciated that that both hardware and software architectures require consideration. Specifically, it will be appreciated that the choice of whether to implement certain functionality in permanently configured hardware (e.g., an ASIC), in temporarily configured hardware (e.g., a combination of software and a programmable processor), or a combination of permanently and temporarily configured hardware may be a design choice. Below are set out hardware (e.g., machine) and software architectures that may be deployed, in various example embodiments.

### Example Machine Architecture and Machine-Readable Medium

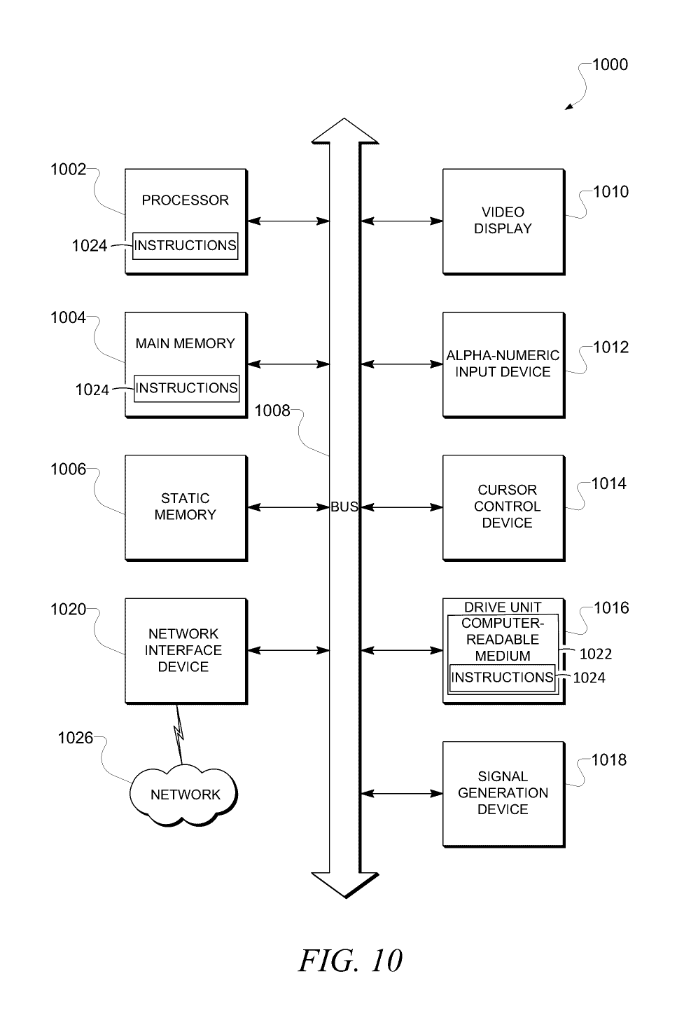

FIG. 10 is a block diagram of machine in the example form of a computer system 1000 within which instructions, for causing the machine to perform any one or more of the methodologies discussed herein, may be executed. In alternative embodiments, the machine operates as a standalone device or may be connected (e.g., networked) to other machines. In a networked deployment, the machine may operate in the capacity of a server or a client machine in server-client network environment, or as a peer machine in a peer-to-peer (or distributed) network environment. The machine may be a personal computer (PC), a tablet PC, a set-top box (STB), a Personal Digital Assistant (PDA), a cellular telephone, a web appliance, a network router, switch or bridge, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computer system 1000 includes a processor 1002 (e.g., a central processing unit (CPU), a graphics processing unit (GPU) or both), a main memory 1004 and a static memory 1006, which communicate with each other via a bus 1008. The computer system 1000 may further include a video display unit 1010 (e.g., a liquid crystal display (LCD) or a cathode ray tube (CRT)). The computer system 1000 also includes an alphanumeric input device 1012 (e.g., a keyboard or a touch-sensitive display screen), a user interface (UI) navigation device 1014 (e.g., a mouse), a disk drive unit 1016, a signal generation device 1018 (e.g., a speaker) and a network interface device 1020.

### Machine-Readable Medium

The disk drive unit 1016 includes a machine-readable medium 1022 on which is stored one or more sets of instructions and data structures (e.g., software) 1024 embodying or utilized by any one or more of the methodologies or functions described herein. The instructions 1024 may also reside, completely or at least partially, within the main memory 1004 and/or within the processor 1002 during execution thereof by the computer system 1000, the main memory 1004 and the processor 1002 also constituting machine-readable media.

While the machine-readable medium 1022 is shown in an example embodiment to be a single medium, the term “machine-readable medium” may include a single medium or multiple media (e.g., a centralized or distributed database, and/or associated caches and servers) that store the one or more instructions or data structures. The term “machine-readable medium” shall also be taken to include any tangible medium that is capable of storing, encoding or carrying instructions for execution by the machine and that cause the machine to perform any one or more of the methodologies of the present disclosure, or that is capable of storing, encoding or carrying data structures utilized by or associated with such instructions. The term “machine-readable medium” shall accordingly be taken to include, but not be limited to, solid-state memories, and optical and magnetic media. Specific examples of machine-readable media include non-volatile memory, including by way of example semiconductor memory devices, e.g., Erasable Programmable Read-Only Memory (EPROM), Electrically Erasable Programmable Read-Only Memory (EEPROM), and flash memory devices; magnetic disks such as internal hard disks and removable disks; magneto-optical disks; and CD-ROM and DVD-ROM disks.

### Transmission Medium

The instructions 1024 may further be transmitted or received over a communications network 1026 using a transmission medium. The instructions 1024 may be transmitted using the network interface device 1020 and any one of a number of well-known transfer protocols (e.g., HTTP). Examples of communication networks include a local area network (“LAN”), a wide area network (“WAN”), the Internet, mobile telephone networks, Plain Old Telephone (POTS) networks, and wireless data networks (e.g., WiFi, LTE, and WiMAX networks). The term “transmission medium” shall be taken to include any intangible medium that is capable of storing, encoding or carrying instructions for execution by the machine, and includes digital or analog communications signals or other intangible media to facilitate communication of such software.

Although an embodiment has been described with reference to specific example embodiments, it will be evident that various modifications and changes may be made to these embodiments without departing from the broader spirit and scope of the invention. Accordingly, the specification and drawings are to be regarded in an illustrative rather than a restrictive sense. The accompanying drawings that form a part hereof, show by way of illustration, and not of limitation, specific embodiments in which the subject matter may be practiced. The embodiments illustrated are described in sufficient detail to enable those skilled in the art to practice the teachings disclosed herein. Other embodiments may be utilized and derived therefrom, such that structural and logical substitutions and changes may be made without departing from the scope of this disclosure. This Detailed Description, therefore, is not to be taken in a limiting sense, and the scope of various embodiments is defined only by the appended claims, along with the full range of equivalents to which such claims are entitled.

Such embodiments of the inventive subject matter may be referred to herein, individually and/or collectively, by the term “invention” merely for convenience and without intending to voluntarily limit the scope of this application to any single invention or inventive concept if more than one is in fact disclosed. Thus, although specific embodiments have been illustrated and described herein, it should be appreciated that any arrangement calculated to achieve the same purpose may be substituted for the specific embodiments shown. This disclosure is intended to cover any and all adaptations or variations of various embodiments. Combinations of the above embodiments, and other embodiments not specifically described herein, will be apparent to those of skill in the art upon reviewing the above description.

What is claimed is:

1. A method comprising:
accessing member profile data and user behavior log data associated with a member of an online social networking service;
generating, based on the accessed data and a plurality of trained intent-specific machine learning models, a plurality of intent prioritization scores associated with a plurality of intents, each intent prioritization score indicating an inferred likelihood that a member of the online social networking service is utilizing the online social networking service in connection with the corresponding intent;
ranking the plurality of intents, based on the plurality of intent prioritization scores;
selecting one or more of the highest ranked intents; and
displaying to the member, via a user interface, the one or more of the highest ranked intents.

2. The method of claim 1, wherein each intent-specific machine learning model is trained by:
accessing a set of feature data associated with each of a plurality of members of the online social networking service, each set of feature data indicating member profile data and user behavior log data associated with the corresponding member and a value indicating whether the corresponding member explicitly specified the relevant intent; and
training, based on the feature data, the corresponding intent-specific machine learning model.

3. The method of claim 1, wherein the intent corresponds to finding a job.

4. The method of claim 1, wherein the intent corresponds to growing the member's network.

5. The method of claim 1, wherein the intent corresponds to hiring another member for a job.

6. The method of claim 1, further comprising:
accessing recommended task information identifying a list of recommended tasks associated with the highest ranked intent; and
displaying the list of recommended tasks via a user interface.

7. The method of claim 6, further comprising:
identifying tasks previously performed by the member;
removing the tasks previously performed by the member from the list of recommended tasks, to thereby generate a modified list of recommended tasks; and
displaying the modified list of recommended tasks via a user interface.

8. The method of claim 1, further comprising:
accessing success metric information identifying one or more success metrics associated with the highest ranked intent;
identifying metric values associated with the identified success metrics; and
displaying the metric values associated with the identified success metrics via a user interface.

9. A system comprising:
a processor; and
a memory device holding an instruction set executable on the processor to cause the system to perform operations comprising:
accessing member profile data and user behavior log data associated with a member of an online social networking service;
generating, based on the accessed data and a plurality of trained intent-specific machine learning models, a plurality of intent prioritization scores associated with a plurality of intents, each intent prioritization score indicating an inferred likelihood that a member of the online social networking service is utilizing the online social networking service in connection with the corresponding intent;
ranking the plurality of intents, based on the plurality of intent prioritization scores;
selecting one or more of the highest ranked intents; and
displaying to the member, via a user interface, the one or more of the highest ranked intents.

10. The system of claim 9, wherein each intent-specific machine learning model is trained by:
accessing a set of feature data associated with each of a plurality of members of the online social networking service, each set of feature data indicating member profile data and user behavior log data associated with the corresponding member and a value indicating whether the corresponding member explicitly specified the relevant intent; and
training, based on the feature data, the corresponding intent-specific machine learning model.

11. The system of claim 9, wherein the intent corresponds to finding a job.

12. The system of claim 9, wherein the intent corresponds to growing the member's network.

13. The system of claim 9, wherein the intent corresponds to hiring another member for a job.

14. The system of claim 9, wherein the operations further comprise:
accessing recommended task information identifying a list of recommended tasks associated with the highest ranked intent; and
displaying the list of recommended tasks via a user interface.

15. The system of claim 14, wherein the operations further comprise:
identifying tasks previously performed by the member;
removing the tasks previously performed by the member from the list of recommended tasks, to thereby generate a modified list of recommended tasks; and
displaying the modified list of recommended tasks via a user interface.

16. The system of claim 9, wherein the operations further comprise:
accessing success metric information identifying one or more success metrics associated with the highest ranked intent;
identifying metric values associated with the identified success metrics; and
displaying the metric values associated with the identified success metrics via a user interface.

17. A non-transitory machine-readable storage medium comprising instructions that, when executed by one or more processors of a machine, cause the machine to perform operations comprising:
accessing member profile data and user behavior log data associated with a member of an online social networking service;
generating, based on the accessed data and a plurality of trained intent-specific machine learning models, a plurality of intent prioritization scores associated with a plurality of intents, each intent prioritization score indicating an inferred likelihood that a member of the online social networking service is utilizing the online social networking service in connection with the corresponding intent;
ranking the plurality of intents, based on the plurality of intent prioritization scores;
selecting one or more of the highest ranked intents; and
displaying to the member, via a user interface, the one or more of the highest ranked intents.

18. The storage medium of claim 17, wherein each intent-specific machine learning model is trained by:
accessing a set of feature data associated with each of a plurality of members of the online social networking service, each set of feature data indicating member profile data and user behavior log data associated with the corresponding member and a value indicating whether the corresponding member explicitly specified the relevant intent; and
training, based on the feature data, the corresponding intent-specific machine learning model.

19. The storage medium of claim 17, wherein the operations further comprise:
accessing recommended task information identifying a list of recommended tasks associated with the highest ranked intent; and
displaying the list of recommended tasks via a user interface.

20. The storage medium of claim 17, wherein the operations further comprise:
accessing success metric information identifying one or more success metrics associated with the highest ranked intent;
identifying metric values associated with the identified success metrics; and
displaying the metric values associated with the identified success metrics via a user interface.
